(19) United States
(12) Patent Application Publication
(10) Pub. No.: US 2019/0250323 A1
(43) Pub. Date: Aug. 15, 2019

(54) LIGHTING DEVICE

(71) Applicant: SHARP KABUSHIKI KAISHA, Sakai City (JP)

(72) Inventor: TSUTOMU OHMORI, Sakai City (JP)

(21) Appl. No.: 16/274,223

(22) Filed: Feb. 12, 2019

(30) Foreign Application Priority Data
Feb. 13, 2018 (JP) 2018-023174

(51) Int. Cl. F21V 8/00

(52) U.S. Cl. CPC G02B 6/0038; G02B 6/0051; G02B 6/0068; G02B 6/0073; G02B 6/0055

(57) ABSTRACT

A lighting device includes a light guide plate having an edge surface, a light source arranged opposite the edge surface of the light guide plate and emitting light toward the edge surface, and a light source board on which the light source is mounted and that includes a light guide plate overlapping section overlapping the light guide plate, and at least a part of the light guide plate overlapping section is welded to the light guide plate at a welded section.

### CROSS REFERENCE TO RELATED APPLICATION

This application claims priority from Japanese Patent Application No. 2018-023174 filed on Feb. 13, 2018. The entire contents of the priority application are incorporated herein by reference.

### TECHNICAL FIELD

The technology described herein relates to a lighting device.

### BACKGROUND

In apparatuses such as electronic apparatuses such as information terminals and instruments provided in vehicles such as automobiles, liquid crystal panels have recently been widely used as display panels that display images and information. Moreover, this type of display device is mounted with a liquid crystal panel and a backlight device (lighting device) that supplies the liquid crystal panel with light.

A known example of a backlight device, such as that disclosed in International Publication No. 2016/093136, is an edge-lighting (or side-lighting) backlight device including a light guide plate constituted by a transparent plate-shaped member and a light source (e.g. an LED) disposed to face an edge surface of the light guide plate. Light emitted from the light source of the backlight device enters the light guide plate through the edge surface (hereinafter referred to as “light entrance surface”) of the light guide plate that faces the light source. Then, the light propagates through the inside of the light guide plate and exits as surface light through a front-side plate surface (hereinafter referred to as “light exit surface”). Such an edge-lighting backlight device has an advantage over another type of backlight device (e.g. a direct backlight device) in being capable of a reduction in thickness.

Incidentally, along with a further reduction in thickness, this type of display device is often constituted by members that are bonded to each other with a thin two-sided tape. For example, two-sided tapes and the like are used to fix an LED board to a chassis in which the LED board, the light guide plate, and the like are accommodated and to an end of a liquid crystal substrate placed opposite the light guide plate.

However, since a thin two-sided tape has thin adhesive layers, a decrease in adhesive strength may cause the LED board to be displaced or misaligned from a predetermined position. Such displacement or misalignment of the LED board leads to a decrease in reliability of a liquid crystal device.

### SUMMARY

The technology described herein was made in view of the above circumstances. An object is to provide a lighting device in which a light source board is less likely to be displaced or misaligned from a predetermined position with respect to a light guide plate.

A lighting device includes a light guide plate having an edge surface, a light source arranged opposite the edge surface of the light guide plate and emitting light toward the edge surface, and a light source board on which the light source is mounted. The light source board includes a light guide plate overlapping section overlapping the light guide plate and at least a part of the light guide plate overlapping section is welded to the light guide plate at a welded section.

According to the foregoing configuration, the light source board is welded to the light guide plate. Therefore, in comparison with a configuration in which these members are positioned to each other with another member interposed therebetween, the precision of a positional relationship between the light source and the light guide plate is improved. Moreover, unlike fixing by a conventional fixing tape, mutual fixing by welding does not become lower in fixing strength due to heat in a range of normal operating temperature, the fixed state can be stably retained.

According to the technology described herein, a lighting device in which a light source board is hardly displaced or misaligned from a predetermined position with respect to a light guide plate is obtained.

### BRIEF DESCRIPTION OF THE DRAWINGS

FIG. 1 is a plan view of a lighting device according to a first embodiment.

FIG. 2 is a partially-enlarged plan view of FIG. 1.

FIG. 3 is a cross-sectional view taken along line A-A of FIG. 2.

FIG. 4 is a cross-sectional view taken along line B-B of FIG. 2.

FIG. 5 is an exploded perspective view of an LED board mounted with a light guide plate and LEDs.

FIG. 6 is a bottom view of an LED board mounted with LEDs.

FIG. 7 is a bottom view of an LED board mounted with LEDs of a lighting device according to a second embodiment.

FIG. 8 is a longitudinal sectional view of a liquid crystal display device.

FIG. 9 is a bottom view of an LED board mounted with LEDs of a lighting device according to a third embodiment.

FIG. 10 is a longitudinal sectional view of a liquid crystal display device.

### DETAILED DESCRIPTION

### First Embodiment

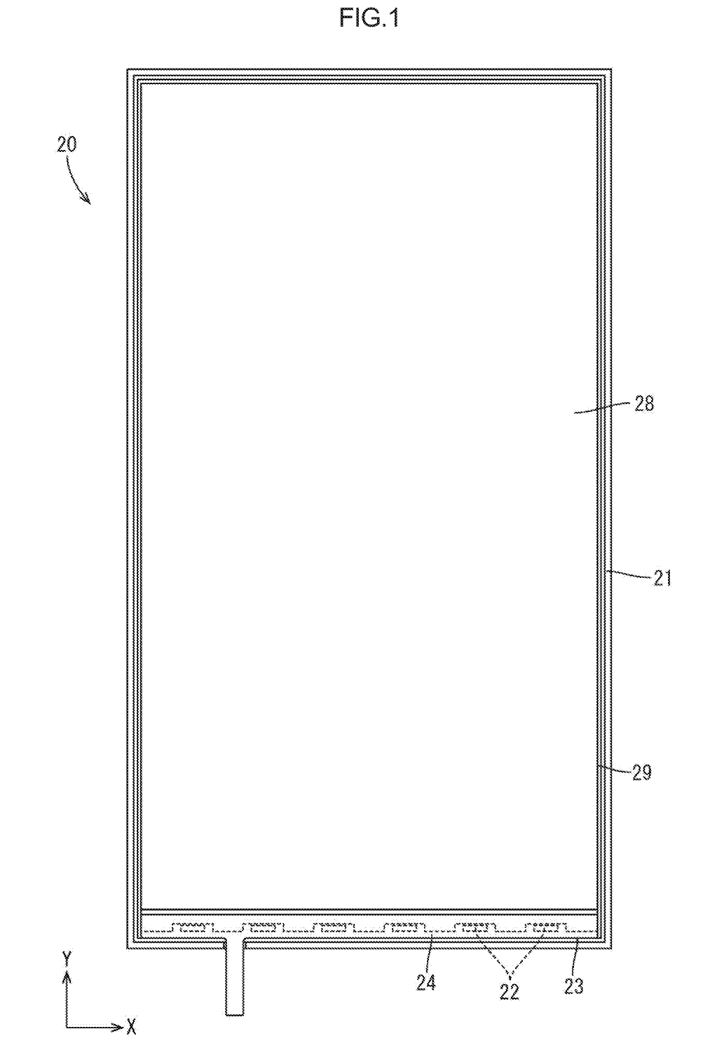

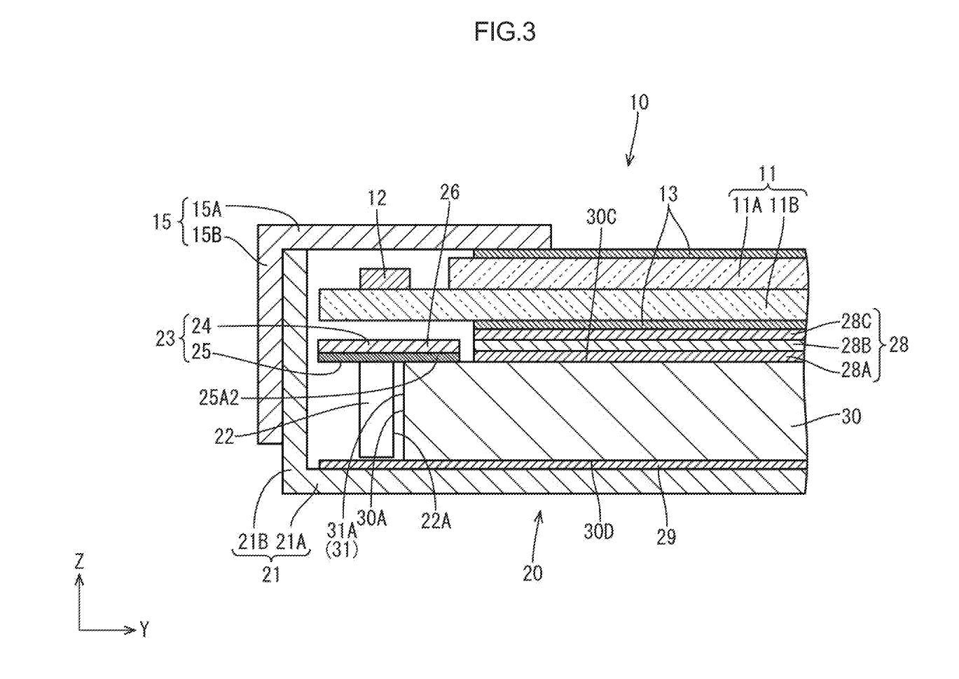

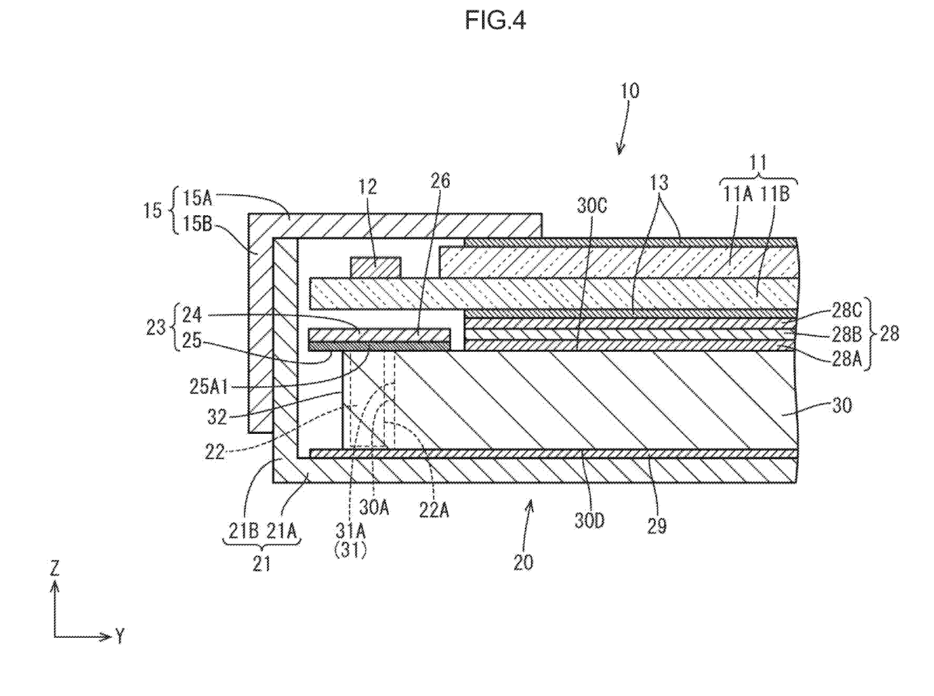

A first embodiment is described with reference to FIGS. 1 to 6. The first embodiment illustrates an embodiment in which a lighting device (backlight device 20) is used in a liquid crystal display device 10 including a liquid crystal panel 11. It should be noted that some of the drawings show an X axis, a Y axis, and a Z axis and are drawn so that the direction of each axis is an identical direction in each drawing. An up-down direction is based on FIGS. 3 and 4, which show the front side up and the rear side down.

The liquid crystal display device 10 has a rectangular shape as a whole. For example, as shown in FIG. 3, the liquid crystal display device 10 includes a plate-shaped liquid crystal panel 11 that is capable of displaying an image and a backlight device 20 (an example of a lighting device), disposed on a rear side with respect to the liquid crystal panel 11, that supplies the liquid crystal panel 11 with light, and is configured such that the liquid crystal panel 11 and the backlight device 20 are integrally held by a frame-shaped bezel 15 and the like. The liquid crystal display device 10 according to the first embodiment is one that is used mainly in a portable electronic apparatus such as a smartphone or a tablet lap-top personal computer, and has a screen size of, for example, approximately 4 inches to approximately 20 inches.

The liquid crystal panel 11 has a rectangular plate shape. The liquid crystal panel 11 includes two transparent (highly translucent) glass substrates 11A and 11B bonded together with a predetermined gap therebetween and a liquid crystal layer disposed between the two glass substrates 11A and 11B. Of the two glass substrates 11A and 11B, the glass substrate 11B on the rear side (lower side in FIG. 3) has its long sides longer in dimension than those of the glass substrate 11A, and has a projecting part provided with a panel drive section 12 for driving the liquid crystal panel 11. Further, the glass substrate 11B is provided with switching elements (e.g. TFTs) connected to source wires and gate wires that are orthogonal to each other, pixel electrodes connected to the switching elements, an alignment film, and the like. The front side glass substrate 11A is provided with a color filter having colored portions such as R (red) portions, G (green) portions, B (blue) portions, and the like arranged in a predetermined array, a counter electrode, an alignment film, and the like. Among these components, the source wires, the gate wires, the counter electrode, and the like are supplied by a drive circuit substrate with image data and various types of control signal that are needed to display an image. It should be noted that a polarizing plate 13 is disposed on the outer side of each of the two glass substrates 11A and 11B.

The liquid crystal panel 11 is able to display an image with use of light that is supplied from the backlight device 20, and has its front side as a light exit side. It should be noted that the liquid crystal panel 11 has its long side direction corresponding to a Y-axis direction, its short side direction corresponding to an X-axis direction, and its thickness direction corresponding to a Z-axis direction.

The bezel 15 is made of a metal material (e.g. aluminum), and has a rectangular frame shape as a whole. The bezel 15 has a panel-holding section 15A that entirely holds the outer peripheral ends of the liquid crystal panel 11 from the front side and an outer cylindrical section 15B that projects from the outer peripheral ends of the panel-holding section 15A toward the rear side and surrounds the outer peripheral sides of the backlight device 20. The liquid crystal panel 11 is held by the bezel 15 so as to be sandwiched between the bezel 15 and the backlight device 20.

As with the liquid crystal panel 11, the backlight device 20 has a substantially blockish rectangular shape as a whole in a plan view. As shown in FIGS. 1 to 4, the backlight device 20 includes a substantially box-shaped chassis 21 having an opening facing the liquid crystal panel 11, LEDs (light-emitting diodes) 22 serving as light sources, an LED board (an example of a light source board) 23 mounted with the LEDs 22, a light guide plate 30 that guides light emitted from the LEDs 22, optical sheets 28 stacked on a front side of the light guide plate 30, and a reflection sheet 29 stacked on a rear side of the light guide plate 30.

The backlight device 20 is a one-side light entrance edge-lighting (side-lighting) backlight device in which the LEDs 22 (examples of light sources) are disposed on an edge surface of the light guide plate 30 along one short side so that light enters the light guide plate 30 through one side only. The backlight device 20 converts light from the LEDs 22 into surface light and emits it toward the front-side liquid crystal panel 11 through the opening of the chassis 21. That is, the backlight device 20 has its front side as a light exit side. The following sequentially describes the components of the backlight device 20.

The chassis 21 is made of a metal material such as an aluminum sheet or an electrogalvanized steel sheet (SECC). As shown in FIG. 1, the chassis 21 has a rectangular shape in a plan view and has a substantially box shape having an opening facing the front side. The chassis 21 accommodates the LED board 23, the light guide plate 30, and the like inside. The chassis 21 has a rectangular bottom section 21A and a side plate section 21B rising from each of the end edges (a pair of long sides and a pair of short sides) of the bottom plate section 21A toward the front side. The bottom plate section 21A of the chassis 21 has its long side direction corresponding to the Y-axis direction and its short side direction corresponding to the X-axis direction.

The bottom plate section 21A supports from the rear side the members accommodated in the chassis 21. The side plate section 21B has a vertically long rectangular frame shape as a whole by being disposed to surround from the outer peripheral side the members accommodated in the chassis 21. The side plate section 21B is surrounded by the outer cylindrical section 15B of the bezel 15 from the outer peripheral side. The side plate section 21B and the outer cylindrical section 15B are each provided with a holding structure and these holding structures allows the chassis 21 and the bezel 15 to be held in an assembled state.

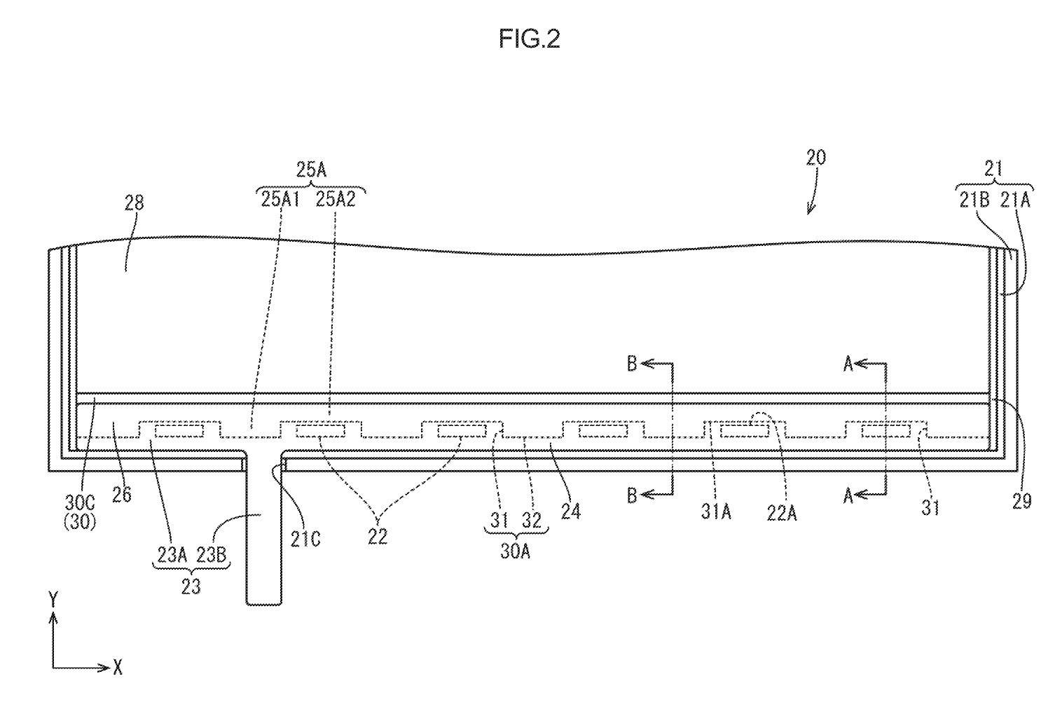

Of the four side plate sections 21B of the chassis 21, the side plate section 21B located in a lower position in FIGS. 1 and 2 (i.e. a side plate section extending inadirection of extension (X-axis direction) of the LED board 23 described below) is provided with a notch 21C through which to draw out an extension portion 23B of the LED board 23 described below.

The LEDs 22 are configured such that LED chips (LED elements) that are semiconductor light-emitting elements are sealed with a resin material on a substrate section that is fixedly attached to a plate surface of the LED board 23 described below. The LED chips that are mounted on the substrate section have one type of dominant emission wavelength and, specifically, emit a single blue color of light. Meanwhile, the resin material with which the LED chips are sealed contains a dispersed combination of a phosphor that emits a predetermined color of light by being excited by the blue light emitted from the LED chips, and emits substantially white light as a whole. The LEDs 22 are side-emitting LEDs whose light-emitting surfaces 22A are side surfaces that are adjacent to surfaces at which they are mounted on the LED board 23.

Each of the LEDs 22 emits through its light-emitting surface 22A light having predetermined spread (directivity) centered at an optical axis. In the case of the first embodiment, the optical axis of the light thus emitted is substantially perpendicular to a central portion of the light-emitting surface 22A.

The LED board 23 includes a base material film 24, made of a thermosetting resin such as urethane resin or epoxy resin, that has a wiring pattern formed thereon to feed electricity to the LEDs 22 and a thermoplastic resin layer 25 such as polyimide resin stacked on the base material film 24, that has thermoplasticity, with the LEDs 22 mounted on a surface of the thermoplastic resin layer 25 in such a manner as to be intermittently arranged (see FIGS. 3 and 4). As shown in FIG. 2, the LED board 23 includes a main substrate section 23A having an elongated band shape whose long side dimension is substantially equal to the short side dimension (X-axis dimension) of the light guide plate 30 described below and an extension portion 23B extending in a vertical direction (Y-axis direction) from the main substrate section 23A and connected to an external circuit. The LEDs 22 are mounted side by side in a line in a substantially central part of the band-like main substrate section 23A in a width direction (Y-axis direction).

The LED board 23 is disposed so that the surface on which the LEDs 22 are mounted (i.e. the surface facing the thermoplastic resin layer 25) faces the rear side (side opposite to the liquid crystal panel 11). Further, the LED board 23 overlaps the front side of the light guide plate 30 along the X-axis direction so that one of the two long sides of the LED board 23 extends along one of the two short sides of the light guide plate 30 that faces a light entrance surface 30A. In the first embodiment, this overlapping region of the LED board 23 is referred to as “a light guide plate overlapping section 26”. As a result, the LEDs 22 are placed opposite so that their light-emitting surfaces 22A are parallel to an edge surface (light entrance surface 30A) of the light guide plate 30 described below on one short side.

The light guide plate 30 is made of a transparent synthetic resin or the like such as acrylic resin or polycarbonate, and is disposed parallel to the bottom plate section 21A of the chassis 21 in the form of a planimetrically substantially rectangular plate that is a size smaller than the bottom plate section 21A of the chassis 21. Further, the light guide plate 30 has its long side direction (length direction) corresponding to the Y-axis direction, its short side direction (width direction) corresponding to the X-axis direction, and its plate thickness direction, which is orthogonal to its plate surfaces, corresponding to the Z-axis direction. The light guide plate 30 is accommodated in the chassis 21 in such a manner as to be surrounded by the side plate sections 21B.

Of the outer peripheral edge surfaces of the light guide plate 30, an edge surface on the left short side shown in FIGS. 3 and 4 serves as the light entrance surface 30A, which faces parallel to the light-emitting surfaces 22A of the LEDs 22 at a predetermined distance and which light from the LEDs 22 enters, as mentioned above. Further, in the first embodiment, of the two plate surfaces, an upper surface (front surface) serves as a light exit surface 30C through which light having entered the light guide plate 30 exits toward the liquid crystal panel 11, and a lower surface (rear surface) serves as a reflection surface 30D that reflects, toward the light exit surface 30C, light traveling from inside the light guide plate 30 toward the lower surface (rear surface).

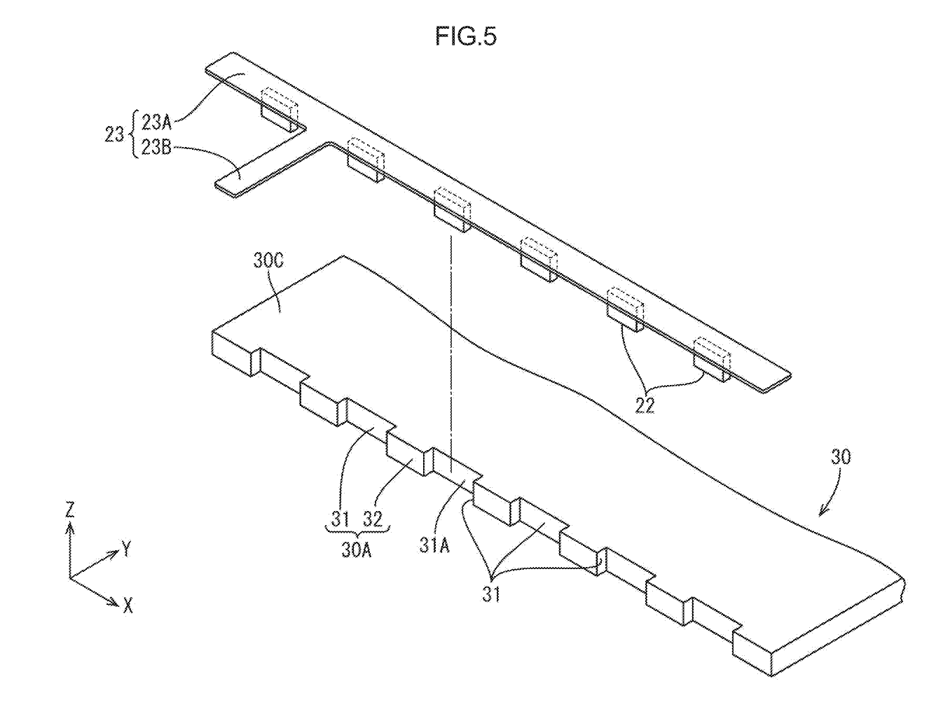

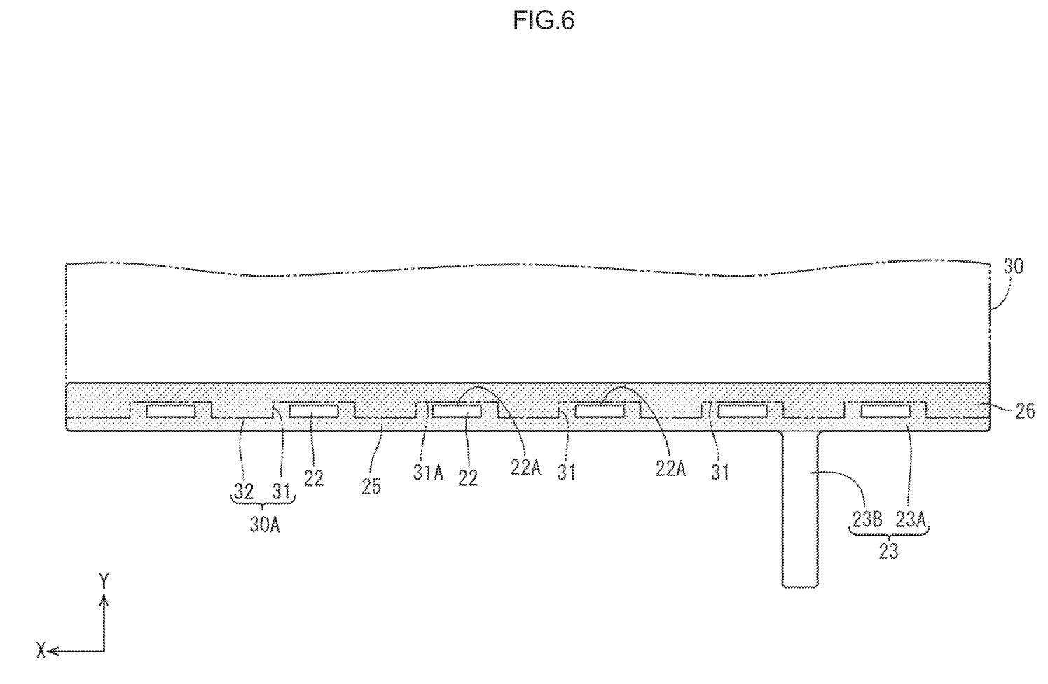

As shown in FIG. 5, regions of the light entrance surface 30A of the light guide plate 30 that face the LEDs 22, respectively, serve as accommodating recesses 31 depressed in the shape of recesses (grooves) all along the plate thickness direction (height direction, Z-axis direction). The width (X-axis dimension) of one accommodating recess 31 is larger than the width of a corresponding one of the LEDs 22 so that the LED 22 can be accommodated in the accommodating recess 31 (see FIGS. 2 and 6). That is, the light entrance surface 30A of the light guide plate 30 has an uneven shape in which recesses (accommodating recesses 31) are arranged along the X-axis direction so that each of the LEDs 22 can be accommodated separately.

In a state where the LED board 23 is fixed in a normal position as will be described later, the LEDs 22 are disposed so that their light-emitting surfaces 22A face bottom surfaces 31A of the accommodating recesses 31, respectively, and light emitted from the LEDs 22 enters the light guide plate 30 through these bottom surfaces 31A. Further, the LEDs 22 have their back surfaces (surfaces opposite to the light guide plate 30) set to be disposed in the accommodating recesses 31, respectively.

Further, a space between two adjacent accommodating recesses 31 serves as an edge surface forming surface 32 that forms an edge surface of the light guide plate 30. In the first embodiment, the light entrance surface 30A is the whole surface constituted by the edge surface forming surfaces 32 and the accommodating recesses 31.

As mentioned above, the band-shaped main substrate section 23A of the LED board 23 overlaps the front side (light exit surface 30C) of the light guide plate 30 so that one of the two long sides of the main substrate section 23A extends along one of the two short sides of the light guide plate 30 that faces the light entrance surface 30A. Further, the other long side of the main substrate section 23A is disposed to protrude from the light guide plate 30, so that the LEDs 22 are disposed in the accommodating recesses 31, respectively. In this state, the light guide plate overlapping section 26 of the LED board 23 is a band-shaped extended region one of whose long sides has an uneven shape extending along an upper edge of the light entrance surface 30A and the other of whose long sides extends in a linear fashion (see FIGS. 2 and 6).

The aforementioned light guide plate overlapping section 26 of the LED board 23 serves as a welded section 25A welded entirely to the light guide plate 30. The welded section 25A is formed by ultrasonically welding, to the light guide plate 30, a region of the thermoplastic resin layer 25 stacked on the LED board 23 that corresponds to the light guide plate overlapping section 26. In other words, the light guide plate overlapping section 26 of the LED board 23 and an area around an end of the light exit surface 30C of the light guide plate 30 that faces the light entrance surface 30A are integrated with each other by the welded section 25A.

More specifically, the welded section 25A is composed of a first welded region 25A1 welded from an upper edge of the edge surface forming surface 32 of the light guide plate 30 toward the light guide plate 30 (Y-axis direction) between adjacent LEDs 22 and a second welded region 25A2 welded along the X-axis direction in a region of the LED board 23 that is closer to the light guide plate 30 than the LEDs 22. It should be noted that the first welded region 25A1 is also provided closer to the ends than the LEDs 22 disposed at both ends.

By thus fixedly welding the LED board 23 directly to the light guide plate 30, it is made possible to improve the precision with which to place the LEDs 22 in position with respect to the light guide plate 30 and keep them in a stable condition. That is, a highly-reliable backlight device 20 in which the LEDs 22 are hardly displaced or misaligned from a predetermined position with respect to the light guide plate 30 is obtained.

The light guide plate 30 to which the LED board 23 has been welded is located directly below the liquid crystal panel 11 with an optical sheets 28 interposed therebetween (see FIGS. 3 and 4).

The optical sheet 28 stacked on the light exit surface 30C of the light guide plate 30 has a flat rectangular sheet shape, and has its long side direction corresponding to the Y-axis direction and its short side direction corresponding to the X-axis direction. By being interposed between the light guide plate 30 and the liquid crystal panel 11, the optical sheet 28 transmits emitted light from the light guide plate 30 and emits the transmitted light toward the liquid crystal panel 11 while imparting a predetermined optical effect to the transmitted light.

The optical sheets 28 according to the first embodiment has a three-layer structure in which a diffusion sheet 28A, a lens sheet 28B, and a reflective polarization sheet 28C are stacked in this order from the lower layer side.

Meanwhile, the reflection sheet 29 is stacked on the rear side of the light guide plate 30 (that faces the reflection surface 30D). The reflection sheet 29 is made of a sheet material, made of synthetic resin, whose surface exhibits white, which is excellent in light reflectivity, and, as such, can efficiently raise, toward the front side (light exit surface 30C), light having exited through the reflection surface 30D after propagating through the inside of the light guide plate 30. The reflection sheet 29 has a rectangular shape in a plan view, and is disposed so that a central portion of the reflection sheet 29 is mostly sandwiched between the light guide plate 30 and the bottom plate section 21A of the chassis 21. The reflection sheet 29 has its outer peripheral ends extending farther outward than the outer peripheral edge surface of the light guide plate 30. Further, an end of the reflection sheet 29 that faces the LED board 23 efficiently reflects light received directly from the LEDs 22 and allows the light to fall on the light entrance surface 30A.

The liquid crystal display device 10 according to the first embodiment is configured as described above, and its working effects are described below.

A backlight device 20 for use in a liquid crystal display device 10 according to the first embodiment includes a light guide plate 30 constituted by a plate-shaped member, an LED 22, placed opposite an edge surface of the light guide plate 30, that emits light toward the edge surface, and an LED board 23 on which the LED 22 is mounted. The LED board 23 has a light guide plate overlapping section 26 overlapping the light guide plate 30, and at least a part of the light guide plate overlapping section 26 is welded to the light guide plate 30 at a welded section 25A.

According to such a configuration, the LED board 23 is welded to the light guide plate 30; therefore, in comparison with a configuration in which these members are positioned to each other with another member interposed therebetween, the precision of a positional relationship between the LED 22 and the light guide plate 30 is improved. Moreover, unlike fixing by a conventional fixing tape, mutual fixing by welding does not become lower in fixing strength due to heat in a range of normal operating temperature, the fixed state can be stably retained.

Further, the light guide plate 30 has a light entrance surface 30A and a light exit surface 30C, the light entrance surface 30A being an edge surface of the light guide plate 30 through which light from the LED 22 enters, the light exit surface 30C being a plate surface through which the light exits, and the light guide plate overlapping section 26 of the LED board 23 overlaps the light exit surface 30C of the light guide plate 30.

Such a configuration makes it easy to secure a wide welding area, as the LED board 23 overlaps the light exit surface 30C, which makes it easier to secure the area of the light guide plate overlapping section 26 than an edge surface of the light guide plate 30. This makes it possible to retain the positional relationship between the LED board 23 and the light guide plate 30 in a more stable condition.

Further, a region of the light guide plate 30 that faces the LED 22 is provided with an accommodating recess 31 in which the LED 22 is able to be disposed. Such a configuration too allows the light guide plate overlapping section 26 to have a wider area, thus making it possible to retain the positional relationship between the LED board 23 and the light guide plate 30 in a more stable condition.

The welded section 25A according to the first embodiment is formed by ultrasonic welding of at least a part of a thermoplastic resin layer 25 provided on a surface of the LED board 23 that faces the light guide plate 30. Such a configuration makes it possible to fix the LED board 23 in a predetermined positon on the light guide plate 30 with high fixing strength by performing a simple task of placing the LED board 23 in a predetermined position on the light guide plate 30 and putting an ultrasound-emitting horn to the LED board 23.

Further, in the first embodiment, the LED 22 includes LEDs 22, and the welded section 25 A is continuously provided over both a space between adjacent LEDs 22 and a region of the LED board 23 that is closer to the light guide plate 30 than the LED 22. This secures a wide welding area, which also makes it possible to increase fixing strength.

Such a backlight device 20 according to the first embodiment makes it possible to obtain a backlight device 20 and a liquid crystal display device 10 in which an LED board 23 is hardly displaced or misaligned from a predetermined position with respect to a light guide plate 30.

### Second Embodiment

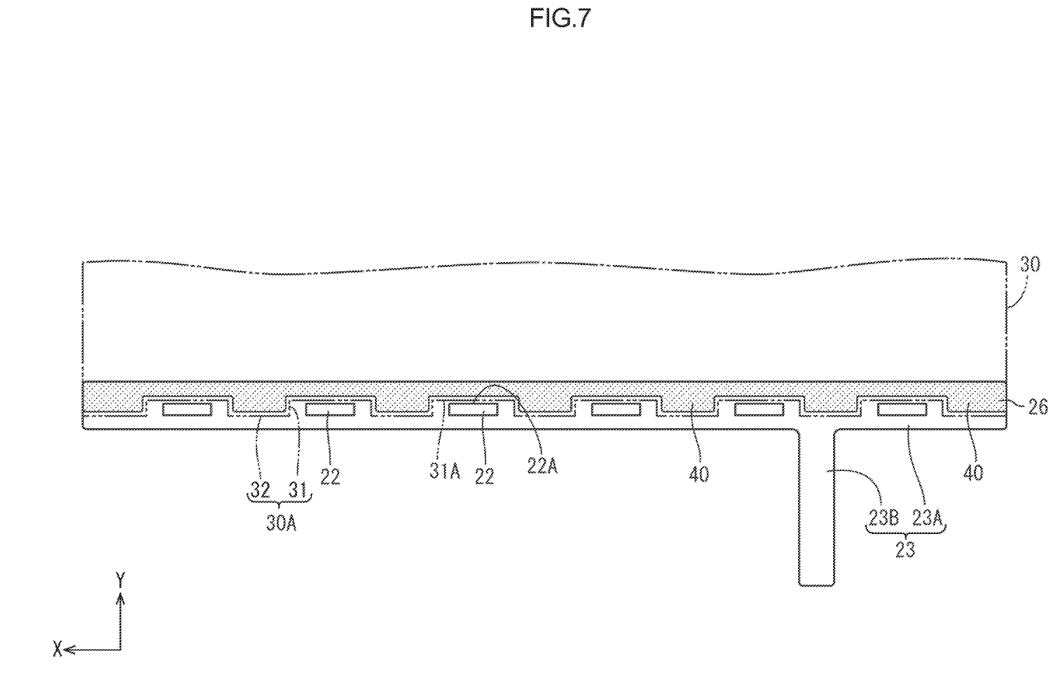

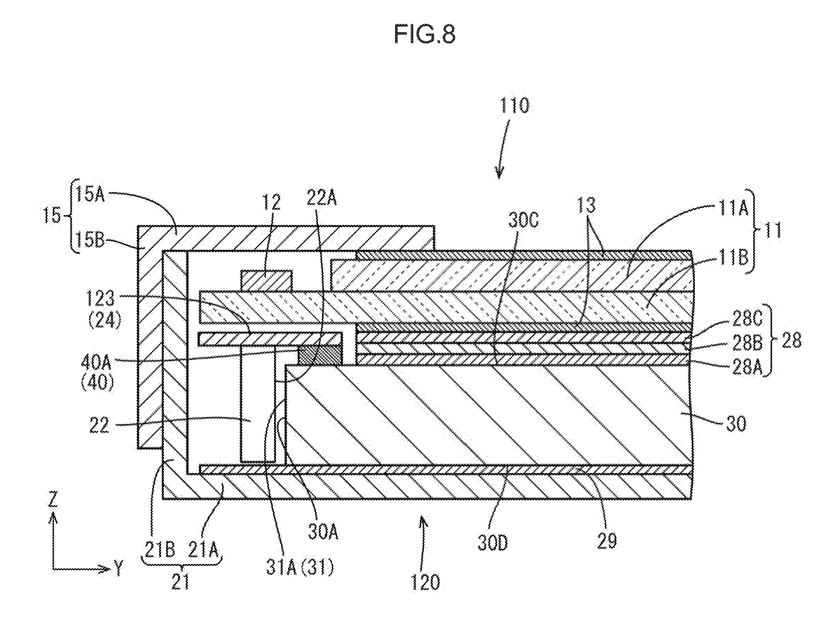

Next, a second embodiment is described with reference to FIGS. 7 and 8. It should be noted that the following describes only components which are different from those of the first embodiment, gives the same signs to components which are identical to those of the first embodiment, and omits to describe the identical components.

A liquid crystal display device 110 according to the second embodiment differs from that according to the first embodiment in terms of the configuration of an LED board 123 of a backlight device 120. Specifically, the LED board 123 according to the second embodiment does not include a thermoplastic resin layer stacked on a surface of the substrate and, instead, is provided with a reinforcing plate 40 made of a thermoplastic resin.

The reinforcing plate 40 is a plate-shaped member that is thicker than the base material film 24 of the LED board 123 and, in a plan view, has substantially the same form as the light guide plate overlapping section 26 according to the first embodiment. Specifically, the reinforcing plate 40 has an elongated band shape, having a length dimension that is equal in dimension to the short sides of the LED board 123, one of whose long sides has an uneven shape extending along an upper edge of the light entrance surface 30A of the light guide plate 30 and the other of whose long sides extends in a linear fashion.

Such a reinforcing plate 40 according to the second embodiment is bonded with high fixing strength with an adhesive in advance to the surfaces of the LED board 123 on which the LEDs 22 are mounted, in order that the linear long side of the reinforcing plate 40 overlaps the long side of the LED board 123 that face the light-emitting surfaces 22A of the LEDs 22. In this state, the long side of the uneven shape of the reinforcing plate 40 is disposed to circumvent the LEDs 22.

Such an LED board 123 according to the second embodiment overlaps the front side (light exit surface 30C) of the light guide plate 30 so that one of the two long sides of the LED board 123 extends along one of the two short sides of the light guide plate 30 that faces the light entrance surface 30A. Further, the other long side is disposed to protrude from the light guide plate 30 so that the LEDs 22 are disposed in the accommodating recesses 31, respectively, of the light guide plate 30. In this state, the reinforcing plate 40 serves as a light guide plate overlapping section 26 wholly overlapping the light guide plate 30 (see FIG. 7). Moreover, the whole of the light guide plate overlapping section 26 (reinforcing plate 40) serves as a welded section 40A welded to the light guide plate 30.

According to such a second embodiment, too, the LED board 123 is welded directly to the light guide plate 30 and fixed to the light guide plate 30 with high fixing strength, whereby the LEDs 22 are kept stably placed in position with respect to the light guide plate 30. That is, a highly-reliable backlight device 120 in which the LEDs 22 are hardly displaced or misaligned from a predetermined position with respect to the light guide plate 30 is obtained.

### Third Embodiment

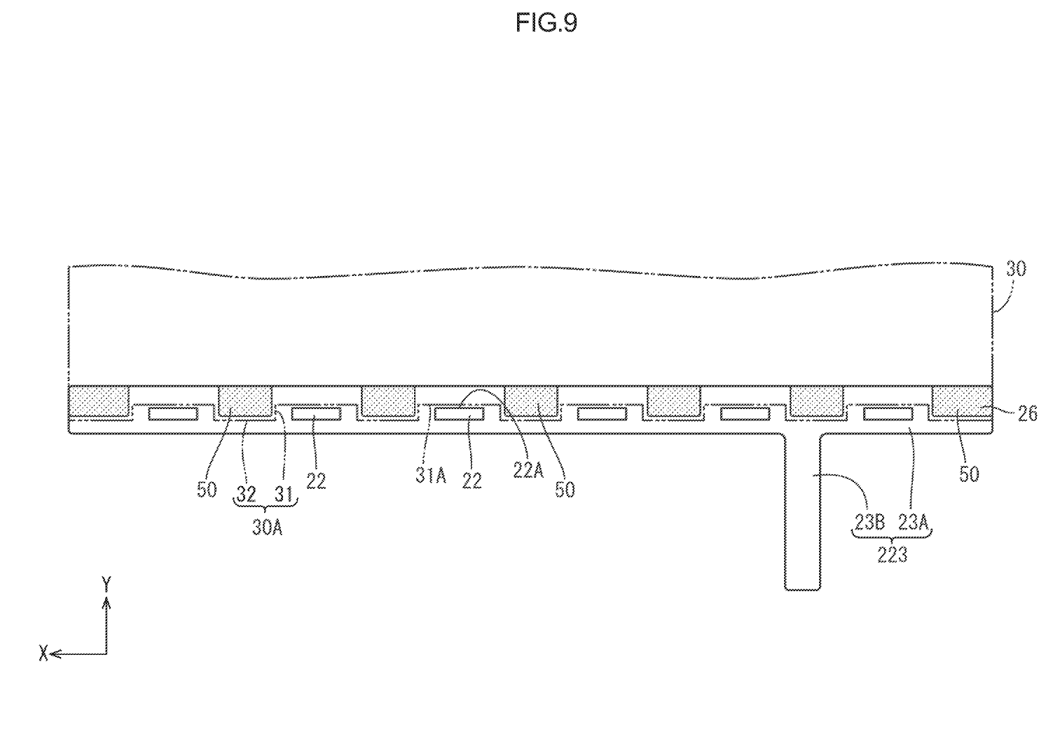

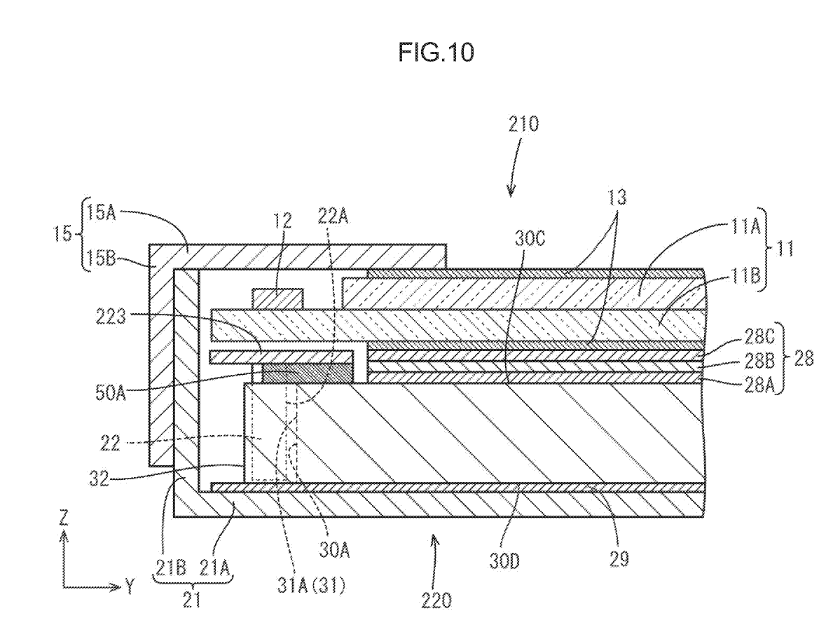

Next, a third embodiment is described with reference to FIGS. 9 and 10. It should be noted that the following describes only components which are different from those of the second embodiment, gives the same signs to components which are identical to those of the second embodiment, and omits to describe the identical components.

The liquid crystal display device 210 according to the third embodiment differs from that according to the second embodiment in terms of the configuration of a reinforcing plate 50 provided on an LED board 223 of a backlight device 220. Specifically, the liquid crystal display device 210 according to the third embodiment differs from that according to the second embodiment in that the reinforcing plate 50 according to the third embodiment is provided only between adjacent LEDs 22 and not provided in a region that is closer to the light guide plate 30 than the LEDs 22. That is, the reinforcing plate 50 according to the third embodiment is identical in planimetric form to the first welded region 25A1 according to the first embodiment. The LED board 223 is fixed to the light guide plate 30 by a welded section 50A formed by ultrasonic welding of the reinforcing plate 50.

According to such a third embodiment, the reinforcing plate 50 is not disposed or is hardly disposed on the path of traveling light emitted from the LEDs 22; therefore, the influence of the reinforcing plate 50 on light is smaller than in the configuration of the second embodiment. The other working effects of the third embodiment are identical to those of the second embodiment.

### Other Embodiments

The technology described herein is not limited to the embodiments described above with reference to the drawings. The following embodiments may be included in the technical scope.

(1) Each of the embodiments described above has shown a configuration in which the LED board is welded to the light exit surface of the light guide plate; however, in the case of a top-emitting LED, the LED board may be configured to be welded to the light exit surface (edge surface forming surface) of the light guide plate.

(2) Each of the embodiments described above has shown a configuration in which the whole of the light guide plate overlapping section or the whole of the reinforcing plate of the LED board is welded to the light guide plate; however, such a configuration is possible that a part of the light guide plate overlapping section or reinforcing plate of the LED board is welded to the light guide plate. That is, the embodiments described above are not intended to limit the range of formation of the welded section.

(3) Each of the embodiments described above has shown a configuration in which the accommodating recesses 31 are provided in the edge surface of the light guide plate that faces the light entrance surface; however, the accommodating recesses 31 may be omitted.

(4) Each of the embodiments described above has shown a configuration in which the LEDs are entirely accommodated in the accommodating recesses, respectively; however, the LEDs may have their back surfaces partially protruding from the accommodating recesses, respectively.

(5) Each of the embodiments described above has shown a configuration in which the welded section is formed by ultrasonic welding; however, the welded section may be formed by another welding method such as laser welding.

1. A lighting device comprising:
a light guide plate having an edge surface;
a light source arranged opposite the edge surface of the light guide plate and emitting light toward the edge surface; and
a light source board on which the light source is mounted and that includes a light guide plate overlapping section overlapping the light guide plate, and at least a part of the light guide plate overlapping section being welded to the light guide plate at a welded section.

2. The lighting device according to claim 1, wherein
the light guide plate has a light entrance surface through which light from the light source enters and a light exit surface through which the light exits, and the light entrance surface is the edge surface of the light guide plate and the light exit surface is a plate surface of the light guide plate, and
the light guide plate overlapping section overlaps the light exit surface of the light guide plate.

3. The lighting device according to claim 1, wherein the light guide plate has a recess in which the light source is arranged and that faces the light source.

4. The lighting device according to claim 1, wherein the light source board includes a thermoplastic resin layer on a surface thereof facing the light guide plate and the welded section is formed by welding at least a part of the thermoplastic resin layer.

5. The lighting device according to claim 1, wherein the welded section is formed by welding a plate-shaped member that is made of a thermoplastic resin and bonded to the light source board.

6. The lighting device according to claim 1, wherein
the light source includes light sources, and
the welded section is provided between the light sources adjacent to each other.

7. The lighting device according to claim 2, wherein the welded section is provided in a region of the light source board that is closer to the light guide plate than the light source.
